(19) United States
(12) Patent Application Publication
(10) Pub. No.: US 2007/0088601 A1
(43) Pub. Date: Apr. 19, 2007

(54) On-line interview processing

(75) Inventors: Ryan C. Money, Salt Lake City, UT (US); Mark W. Newman, Sandy, UT (US); Jacob C. Hanson, Salt Lake City, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: HireVue, Salt Lake City, UT (US)

(21) Appl. No.: 11/400,547

(22) Filed: Apr. 7, 2006

Related U.S. Application Data
(60) Provisional application No. 60/669,460, filed on Apr. 9, 2005.

(51) Int. Cl. G07G 1/00

(52) U.S. Cl. 705/10

(57) ABSTRACT

An interview method and system that allows a hiring individual to use a networked computer system to interview candidates without requiring the hiring individual to participate personally during the interview by devoting time and resources to a meeting, the capability of conducting on-line interviews is provided using generic or customized interview questions, collecting unrehearsed answers, distributing the answers to evaluators, accumulating the evaluations and provides the reporting capability consistent with the objective of clear and consistent hiring practices. A real time interview can be conducted in that the interviewee answers questions in real time, while it provides for the later evaluation and review of this interview.

### CROSS-REFERENCE TO RELATED APPLICATIONS

This application claims the benefit of U.S. Provisional Application No. 60/669,460 titled METHOD AND SYSTEM FOR INTERVIEW PROCESSING, filed on Apr. 9, 2005, which is incorporated herein by reference in its entirety.

### BACKGROUND

### Background and Relevant Art

Interviewing of candidates, particularly in the employment context, college admissions context and the like, is well known in the art. However, typically, known methods and processes for interviewing candidates are constrained in that they require an interviewer to conduct in-person interviews for a number of candidates, summarize the conducted interviews and provide the summary to others interested in hiring or admission decisions. Thus, evaluation of candidates typically includes decisions made based on hearsay accounts provided by the in person interviewer.

In addition, interviews are typically conducted with one individual person at a time in a private setting. As such, memories can become faded and direct comparisons of candidates are difficult. For example, it is often difficult to directly compare one candidate's response to a given question to another candidate's response to the same question. This is due to the disjoint in time nature of in person interviewing.

Questionnaires and forms, which may allow for side-by-side comparisons, lack the ability to evaluate a candidate's physical demeanor and responses. Additionally, it is difficult using questionnaires and forms to place pressure time constrains on the candidate so as to elicit an impromptu response.

The subject matter claimed herein is not limited to embodiments that solve any disadvantages or that operate only in environments such as those described above. Rather, this background is only provided to illustrate one examplary technology area where some embodiments described herein may be practiced.

### BRIEF SUMMARY

It is desirable to provide a method and system for enhancing the efficiency of the interview process. Furthermore, it is particularly desirable to provide such a method and system, which provides an on-line mechanism for collecting information and impressions of a candidate in a systematic and consistent matter.

One embodiment described herein allows for interview questions to be sent from a server to an interviewee client computer. An interviewee at the interviewee client computer provides responses which are received at the server computer. The server computer can then provide the response to an evaluator at an evaluator client computer. The interview questions may be a standard set of questions for a particular interview that are asked of all interviewees taking the interview. An evaluator at the client computer can use user interface tools to interviews. The user interface tools allow for an evaluator to navigate an interview by navigating to particular interviewees and/or particular questions and their corresponding responses. In one embodiment, interviewees provide responses to questions using a video camera and microphone connected to an interviewee client computer which streams the responses to the server computer. The server computer can then stream these responses to the evaluator client computer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a process diagram of the top-level steps of one embodiment;

FIG. 2 illustrates a detailed view of the designing and conducting step of one embodiment;

FIG. 3 illustrates a detailed view of the viewing and evaluating step of one embodiment;

FIG. 4 illustrates a detailed view of the job seeker initiated interview and organization review step of one embodiment;

FIG. 5 illustrates a detailed system diagram of one embodiment;

FIG. 6 illustrates a second detailed system diagram of one embodiment;

FIG. 7 illustrates an exemplary user interface for viewing interviews;

FIG. 8 illustrates a communication flow diagram illustrating messaging from a server

### DETAILED DESCRIPTION

Embodiments herein may comprise a special purpose or general-purpose computer including various computer hardware, as discussed in greater detail below.

Embodiments described herein may include is a software and computer system tool that facilitates the efficient interviewing of individuals, typically for jobs or college admissions, by providing a mechanism for collecting real time information from candidates without requiring a real time meeting. This tool enhances the interview process by facilitating the creation of interview which may include multiple choice, yes/no, true/false, short answer questions and video recorded questions. By “real time information gathering” the inventor means that the person being interviewed (hereafter the “interviewee”) is asked questions and promptly gives unrehearsed answers. In some embodiments, the time the interviewee takes in responding is recorded along with the answer. This ensures that the interview does not have an opportunity to rehearse answers or receive assistance. In other embodiments, the interviewee may be given a limited amount of time to review a question and to answer a question. For example, an interviewee may be given 30 seconds to read a question, and two minutes to respond to the question. These times are exemplary, and other times may be used in alternative embodiments. In the present embodiment, the video recorded questions store a video of the interviewee responding to selected questions in addition to the responses themselves. This approach provides a realistic interview scenario for these questions because the person(s) evaluating (hereafter the “evaluator”) the interview is provided more than simply the answers given by the interviewee, but also the demeanor and responsiveness of the interviewee. Moreover, this technique helps to minimize the possibility that the interviewee will receive assistance in giving answers to the questions.

After the interview is taken, the evaluator can not only evaluate and comment on the interviewees themselves, but can also pass the collected interview information to others for their evaluation. As the evaluators score the interviewees, this process collects and compiles the resulting scores into a clear summary format, appropriate for printing for management review and legal compliance. One embodiment also provides the mechanism for job seekers, potential interviewees, to take and have stored a generic interview for the industry or job of their choice. The interview information and interviewee biographical information are then stored in a database, which is made available to potential employers for review, consideration and as an aid in recruiting.

The following example is provided to illustrate the use of one or more embodiments in the following description. A company has an open position for a Sales Representative. A number of applications are received. The company's initial review of the applications narrows the number of applicants to ten. Embodiments can then used to create, implement and evaluate an on-line interview for the ten candidates. An administrator of the company enters the questions, which are appropriate for the candidate evaluation into the process of some embodiments. Typically, the administrator also enters the names of the candidates, the basis for evaluation and the list of evaluators who will review the interviews and evaluate them. The candidates are contacted, typically by email, and the interview is conducted, typically using a computer with a web cam networked through the Internet to a server computer (hereinafter the “process computer”) executing the process of some embodiments. The candidate may be provided with an interview code that can be entered when the candidate accesses an on-line interview site. The interview information is captured and stored. The evaluators then login to the process computer and watch the interviews and evaluate the candidates. The evaluation is entered into, received and stored in the process computer for subsequent summarizing and reporting.

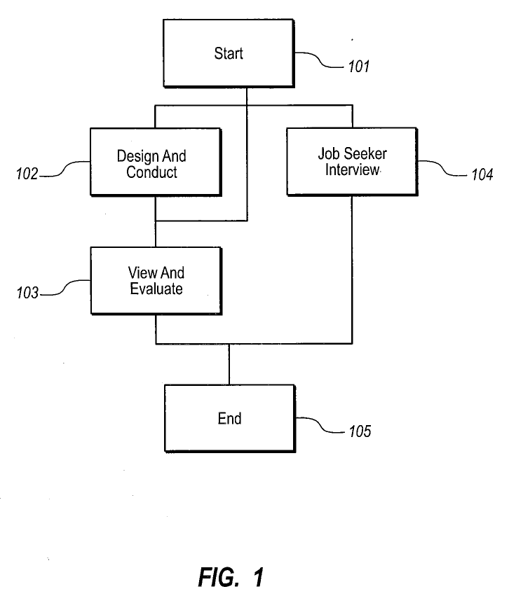

FIG. 1 shows a process diagram of the top-level steps of the present embodiment. The process starts 100 with an administrator, evaluator and/or interviewee (an interviewee may be referred to interchangeably in this disclosure as a candidate) accessing the system. The proposed interview is designed and conducted 102. The interview is viewed and evaluated 103. If the person accessing the system is a potential interviewee, the job seeker accesses an interview 104, typically either a generic interview for storage and future review by an evaluator or an invited interview. The process ends 105 with the user(s) (administrator, evaluator and/or interviewee) logging off the system.

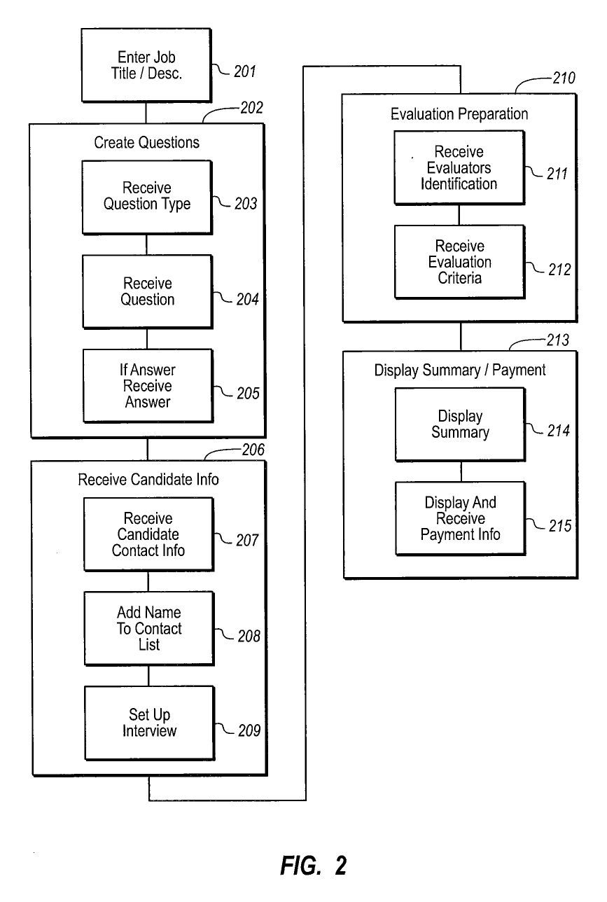

FIG. 2 shows a detailed view of the designing and conducting step 102 of the present embodiment. The job title and description are entered 201. In the present embodiment the job title acts as the primary key for the design of the interview. The job description entered is associated with the job title. As different interviews are created, the job description is “attached” to the associated job title that is populated in the “Job Title” drop down box. Presently, the interview questions entered in the next step 202 are also saved as “attached” to the current job title. An advantage of this approach is that this approach is effective for organizations which intend to use the same questions for interviews and/or who hire multiple people for the same job. Essentially, as the process is used more and more, it becomes more automatic in its use with interviews created more quickly.

Referring to the Sales Representative Example, if an interview is created with the job title being “Sales Rep 1” with its appropriate job description, each time a user (administrator or evaluator” enters “Sales Rep 1” as the job of interest, the job description and previously entered interview questions automatically populate the interview creation screens of this process, thus speeding up the interview creation process. Questions are created 202. The questions creation step 202 presently permits the user to select and input the type of question, which is, received 203 by the process. Question types may be, for example: (1) audio/video recorded questions; (2) multiple choice questions; (3) true/false questions; (4) yes/no questions; (5) short answer questions, where the interviewee is asked to type in a response; and (6) uploaded file document based questions, such as a diagram, a section of text, mathematical problems and the like with one or more questions asking the interviewee to view and analyze the file document. For each question, the type is received 203 by entering the type from a pull-down menu. Other embodiments allow for text boxes, radio buttons, and the like to be used to designate the question type. The question itself is then received 204, presently by being entered into a text box field in the display screen. If the question has a “correct” answer, this answer is received 205, presently by the selection of an “answer available” box and the receipt of the answer in a text box field in the display screen. Again referring to the “Sale Rep 1” example, each time the administrator or evaluator uses “Sales Rep 1” as the job title of interest, the questions previously entered are automatically populated in the “Create Questions” screen or menu. In one embodiment, this ensures that the questions for the same job can be asked in the same order and the same fashion for each interviewee, thereby standardizing the interview process and avoiding potential legal or policy problems in the hiring procedure. The candidate information is received 206. During this 206 step, the candidates contact information (name, address, telephone number, fax number, email address and the like) are received 207 and saved. The candidate's name may be added 208 to an editable list for contacting and tracking. An interview is set up 209 by using an appropriate contact method. In some of the presently envisioned embodiments, a contact method may include one or more of the following: automatically generated letters, faxes or email and/or a voice synthesized automatic phone call or the like. Preparation 210 for the evaluation is performed. In the present embodiment, this preparation further includes receiving 211 the names (and contact information in some embodiments) of the desired evaluators. These evaluators are typically the people in the hiring organization that will have access to the interviews. These individuals are then typically contacted by email (from their received contact information) giving them a list of individual interviews to be evaluated, a login code and a password. Some embodiments support the use of single evaluators or a “committee” including of a group of evaluators. The evaluation criteria 212 is received in order to assure that the candidates are evaluated using a standard criteria by the evaluators. For example, some received criteria could be such skills as “communication skills” or “negotiating skills”. Once received, the present process can provide the criteria for evaluation to the evaluators as a matrix or Cartesian coordinate system with the criteria as the axis. A display 213 of the summary and payment information is made. Presently, the summary and payment information screen (or page) is a printable page that shows the data (job title, job description, interview questions, candidate information, access information, evaluation criteria and the like) that has been entered and provides options for payment for the service of this process. Currently envisioned payment options include: direct account, credit card and the like.

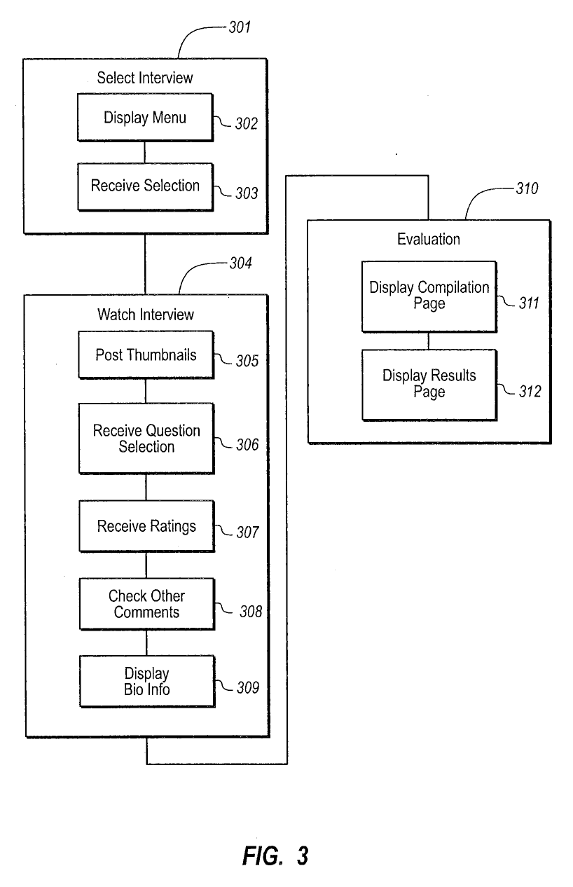

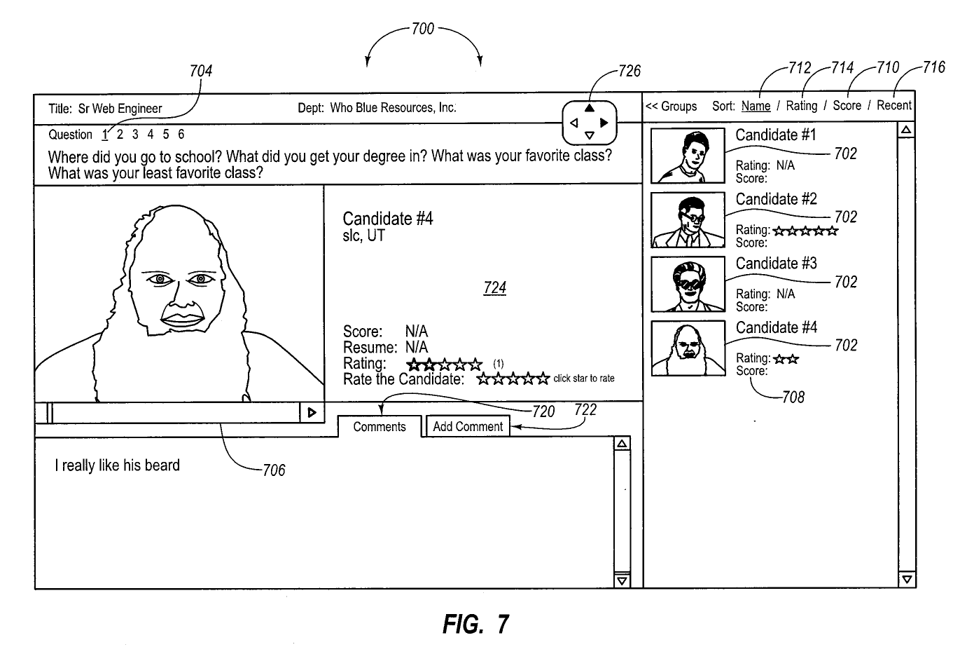

FIG. 3 shows a detailed view of the viewing and evaluating step 103 of the present embodiment. FIG. 3 and the associated steps will be discussed in conjunction with the graphical user interface 700 illustrated in FIG. 7. Interviews are selected 301 for viewing. This selection step 301 presently begins with a display of the interview menu 302, which lists interviews created to which the user will have access. This menu list presently includes the date the interview was created, the job title and the number of interviewees who have taken the interview out of the number requested (for example “14 of 18”). This menu is also provided with the capability of organizing the list of interviews be either date created or by job title. The interview selection is received 303. Once, the desired interview is selected, the interview can be watched 304. FIG. 7 illustrates a selected interview. The example shown in FIG. 7 illustrates conducted interviews for a Sr. Web Engineer job for Who Blue Resources, Inc. During step 304 the user (typically an administrator or evaluator) can watch the interviews and evaluate the candidates. The candidate's thumbnail pictures 702 (FIG. 7) taken from the interview are posted 305, presently on the viewer's computer display. The user then can select which question 704 (FIG. 7) he or she wishes to watch from whichever candidate they choose. Once this selection is received 306, in the present embodiment, a recorded clip 706 (FIG. 7) showing the interviewee answering the selected question can be displayed if related to a video recorded question, presently using streaming video. In one embodiment, the video may be displayed using Macromedia Flash-based streaming available from Adobe Corporation of San Jose, Calif.

If there are gradable questions in the interview of interest, such as multiple choice, true/false or yes/no, the candidates test score 708 (FIG. 7) is presented in a display of the scores of all of the candidates. Candidates can be sorted by score as illustrated at 710 (FIG. 7), such as for example, with the best score located at the top of the list. Notably, candidates may alternatively be sorted by name illustrated at 712, rating illustrated at 714, or be how recently they were interviewed as illustrated at 716 (FIG. 7).

As the users watch the candidates answer the questions, they can input their ratings of the candidates. For example, FIG. 7 illustrates at 718 that a user may rate a candidate on a 5 point scale by selecting a number of stars. These ratings are received 307 into the process storage. Presently, the ratings are in a 1-5 scale to better organize which candidates the user likes or dislikes and to present the evaluation in the matrix section.

The user may also enter comments in a comments section and in some embodiments the user may choose to see comments from other users who have viewed the interview. For example at 720 in FIG. 7, a user can review comments, and at 722, a user may add comments in a text box field. The candidate's biographical information may be displayed 309. For example, in FIG. 7, the candidate's biographical information may be displayed at 724. Presently, this biographical information may be adapted from an uploaded resume (from either the candidate or the interviewer's organization). The biographical information may include the results from questions (some or all) and the results on gradable questions. This display of biographical information and results may be presented, for example, in a document format such as a PDF format, to permit the answers, and the biographical information, to be viewed and printed along with the evaluation. After the candidates have been evaluated, the administrator or other designated evaluator on the account are provided the capability to effect an overall evaluation 310 by viewing a displayed 311 page, such as the graphical user interface 700 shown in FIG. 7 that has a compilation of all results and evaluations of the candidates. A results page is also displayed 312 to display comments and evaluations from the evaluators who reviewed the candidates. This results page can also be printed, in some embodiments with the compilation page, to be kept in a file for legal and other compliance documentation.

Additional functionality is also illustrated in FIG. 7. The graphical user interface 700 further includes tools for customized evaluation of candidates either individually or as a group. For Example, FIG. 7 illustrates a navigation button 726 that may be used to navigate questions and candidates. For example, up and down arrows on the navigation button 726 allows a user to scroll through candidates. For example, the example FIG. 7 shows details of a candidate name Candidate #4. Selecting the up arrow of the navigation button 726 will cause details of Candidate #3 to be displayed at 724. As mentioned previously, the navigation button 726 also allows for selection of questions. For example, question number 1 is currently displayed in the graphical user interface 700. By selecting the right arrow of the navigation button 726, question number 2 can be viewed, and the candidate's video response can be watched. After watching a candidates response to a particular question, a different candidates response to the same question can be watched either by navigating candidates using the up and down arrows of the navigation button 726 or by selecting a link directly-associated with the candidate.

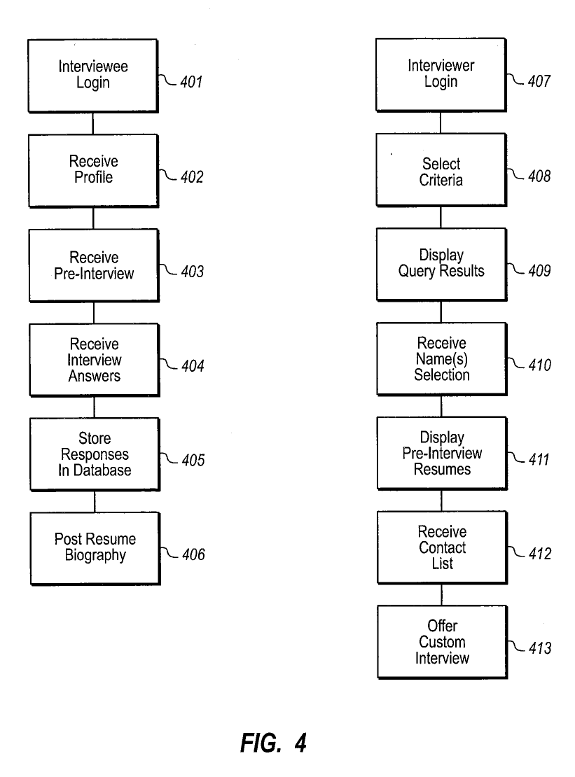

FIG. 4 shows a detailed view of the job seeker initiated interview and organization review step 104 of the present embodiment. A person seeking a job can use the process of some embodiments to both respond to an invitation for an interview and to post answers to generic questions specific for the persons' industry, career or vocation. The interviewee logs in 401 to the process. When the interviewee enters profile information such information is received 402 by this embodiment. A pre-interview is conducted and received 403. The interview questions, whether a generic interview or the specific invited interview, conducted with the interviewee being presented a series of questions, which depending of the type of question they either answer verbally, while being video recorded, or by typing or selecting their answering in the appropriate location in a screen page on their computer by either entering a textual response or selecting one of a multiple choice or true/false response. As noted previously, interviewees may also enter responses by providing scanned or digital images. Typically, interviewees are timed during the answer process so as to ensure that excess time that might be associated with receiving help is identified. Alternatively, the interviewee may be given a limited amount of time to read and comprehend a question, and a limited amount of time to respond to a question. Notably, one embodiment is designed such that an interviewee may only answer a question a single time. Stated differently, an interviewee may not rerecord video responses or reenter text or selection responses. The interviewee's answers are received 404. The answers along with the interviewee's profile and pre-interview information are stored 405 in the database and the interviewee is given the opportunity to post 406 his or her resume to the database as well. Again, referring to the Sales Associate job offering example. The interviewee will typically, login, input their personal information and, optionally, upload their resume. They are given the opportunity to select the field or job type of interest. In this case, they would select “Sales” as their category, they are then typically asked a few generic questions that are asked of all interviewees who select “Sales” as their category. The answers to these questions, their personal information, resume if uploaded and the questions to the on-line interview are then stored in the database, and potentially posted to the appropriate web site.

Organizations looking for individuals from the database for hiring, first login 407. A query page is presented where the hiring person selects 408 the criteria that should be matched by job seekers. The results from this query are presented 409, typically using a tiered approach with the first level being job seekers that are exact matches, the second tier being close matches, and etc. After receiving a list of job seekers the hiring person can select from a list of names that he or she wishes to review. This selection is received 410 and the pre-interview information and resumes of the job seekers are displayed 411. After reviewing this information, the hiring person can add the name of one or more job seekers to the list for contact. The contact list is received 412 and the hiring person is offered 413 the opportunity to invite persons to take an invited specific interview. If an invited interview is selected, the hiring person is given the opportunity to design an interview as described above with regard to step 102.

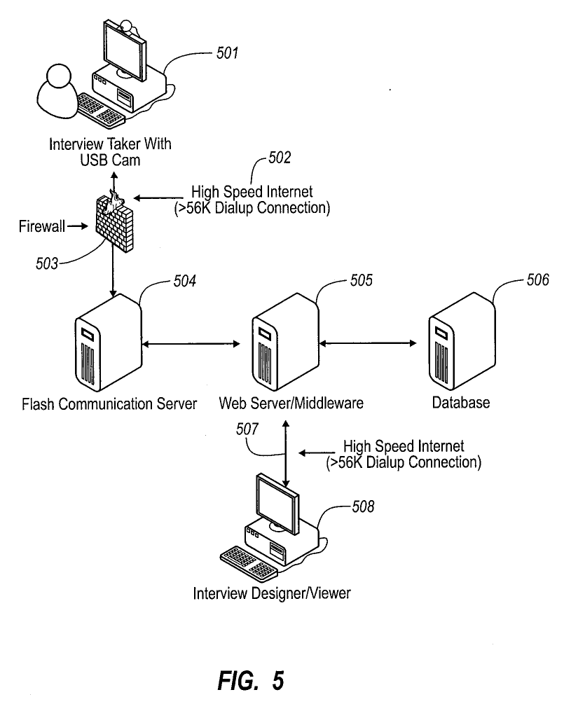

FIG. 5 shows a detailed system diagram of the present embodiment. This figure shows the present computer hardware configuration used in the interview design and interview taking steps of the process. The administrator uses a standard computer system 508 preferably with a high speed Internet connection 507 to a Web Server 505. The process of some embodiments typically resides on the Web Server 505. The Web Server 505 is in communication with the database 506 as well as with, in this example, a Flash Communication Server 504, which is provided to facilitate communication with interviewees. The Flash Communication Server 504 communicates with the interviewee typically over a high speed Internet connection 502. A firewall 503 is provided to protect the security of the Servers 504, 505 and the Database 506. The interviewee, using a standard computer system with a Web Camera 501 interfaces over the Internet preferably using a high speed Internet connection to answer questions, upload information and conduct one or more interviews. The standard computer systems used by the administrator 507 and the interviewer 501 may be high-speed digital computers, network compatible, with sufficient memory and hard disk space to adequately download and interact with Web pages.

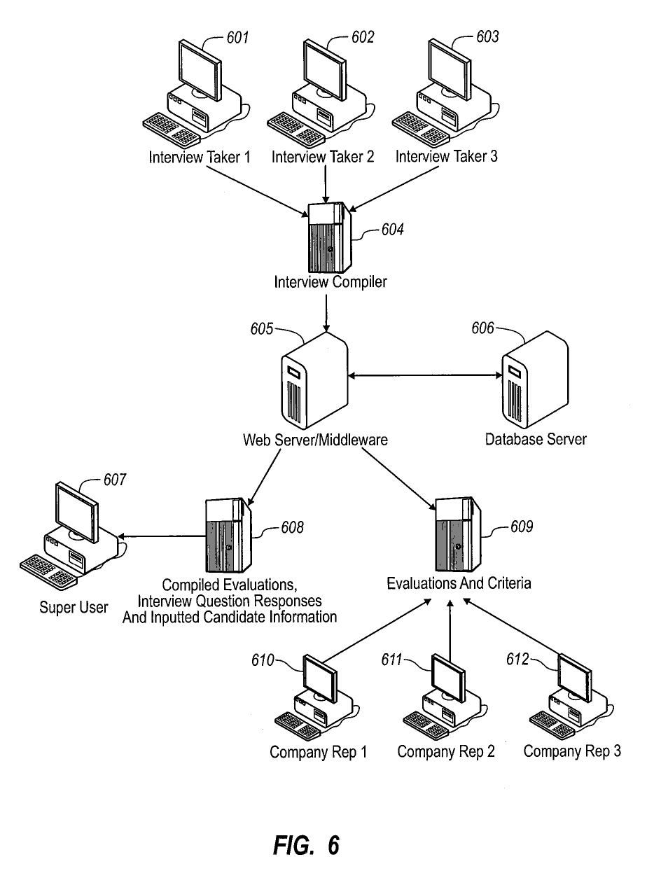

FIG. 6 shows a second detailed system diagram of a present embodiment. This figure shows the present computer hardware configuration used in the interview and evaluation process steps of this embodiment. One or more interviewees access the interview computer 604 using networked personal computers 601, 602, 603. The interview computer 604 is connected over a network connection to the Web Server 605, where the process of this embodiment typically primarily resides. The Web Server 605 is connected to the database server 606, where the stored data resides. This embodiment of the hardware configuration provides for access to the Web Server 605 by a super user, using a personal computer 607, who is connected to a storage server 608 which stores such information as compiled evaluations, interview question responses and inputted candidate (interviewee) information, as well as one or more evaluators, using networked personal computers 610, 611, 612 who are connected to an evaluation storage server 609, which stores information on evaluations and criteria in process.

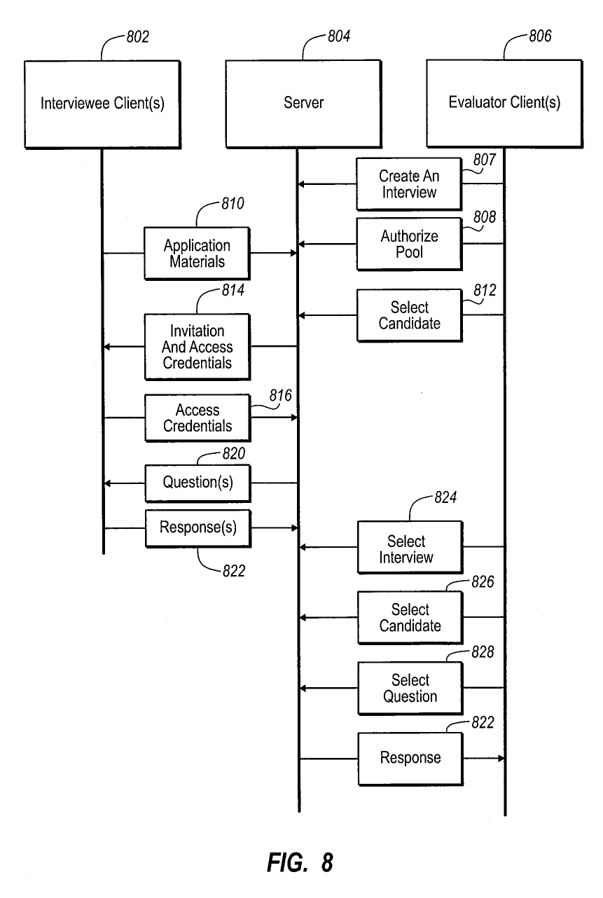

Attention is now directed to FIG. 8 which illustrates a process flow diagram illustrating the process of conducting an on-line interview. FIG. 8 illustrates interviewee clients 802, a server 804, and evaluator clients 806.

The interviewee clients 802 may include any one of a number of clients which may be embodied, for example, as client computer systems being connected via a high-speed internet connection or other suitable network connection. In one embodiment, one or more of the interviewee clients 802 may be located at an on-site interview facility. In this example, interviewees can access the interviewee clients 802 by visiting an office or other location where computer systems have been set up by an organization wishing to have candidates take interviews. The computers may have cameras, such as webcams, connected to the computer system. The computer system of the interviewee clients 802 in this embodiment may be connected to the server 804 through an internet connection, local area network (LAN) connection, other wide area network (WAN) connection, or through any other suitable client to server connection.

In an alternative embodiment, one or more of the interviewee clients 802 may be located off site. In this example, an interviewee may use their own personal web cam and microphone, or may be provided with a web cam and microphone that can be connected to a personal computer at home or some other off site location that can serve as the interviewee client 802. Additionally, as some of the actions between the interviewee clients 802 do not require a video feed and can be conducted at different times, the different interviewee clients 802 can be used at different locations for different portions of the interview process even when some of the interviewee clients 802 do not have access to a video camera and microphone. In embodiments where the interviewee client 802 is off site, the interviewee client 802 should have access to an Internet connection with sufficient speed to transmit appropriate data. For example, lower speed connections may be used to transmit textual application materials or textual responses to questions. However, a higher speed connection should be used to stream video responses to the server 804.

In yet another alternative embodiment similar to the on-site example above, a campus network may be used to provide suitable computers and network connections to enable the interviewee clients 802. In this embodiment, a company can design and post a request for interviews to a college career center. The career center or company can then invite applicants to sit for an interview on-campus.

The server 804 coordinates messaging for inviting candidates to interview, receiving candidate's application materials, taking the candidate's interview, and providing the interview to evaluators. While a single server 804 is shown, it should be understood that the server 804 may include one or more servers such as the Flash Communication server 504, Web Server 505, and Database server 506 all shown in FIG. 5, or any other suitable server configuration. The server 504 may be operated by a hosting company that manages the process of taking interviews, storing interviews, and providing interview for viewing by evaluators. In one embodiment, the hosting company may provide custom build capabilities such that a client company can select various appearance and interview constraints. For example, the client company may be able to specify branding an appearance of user interfaces seen by candidates at the interviewee clients 802 as well as interfaces seen by users at evaluator clients 806. Notably, in one alternative embodiment, a company may choose to host their own interview server 804 for various reasons, including to reduce the amount of Internet traffic from a company to an interview server hosting company.

The evaluator clients 806 may be implemented in a number of different ways. For example, the evaluator clients 806 may be home computers of evaluators where the home computers are connected to a suitable Internet connection. In an alternative embodiment, the evaluator clients 806 may be company computers that are connected to the server 804 through a company LAN, WAN, or other suitable connection. While evaluator clients 806 is used as a descriptor, it should be understood the one need not necessarily evaluate an interview to use an evaluator client 806. For example administrators, managers, and the like may use evaluator clients to create interviews, assign user rights, schedule interviews, add candidates to interviews, and the like, as illustrated in more detail below, but do not need to necessarily evaluate any interviews.

FIG. 8 illustrates that messages for creating an interview 807 are sent from an evaluator client 806 to the server 804. As will be described further herein, the ability to create an interview may be limited by role. For example, only certain job titles within a company may be able to create interviews. When creating an interview, a user at an evaluator client may upload questions, specify the question type, specify an amount of time allowed to answer the question, etc. The user may also specify the job title and other information as explained previously herein.

FIG. 8 illustrates that the server 804 receives one or more pool authorization messages 808 sent from an evaluator client 806. The pool authorization messages 808 are optional message that can be used to authorize an organization to define a pool of potential candidates. For example, in one embodiment, a pool authorization message 808 may be sent by a company representative at an evaluator client 806 that specifies that a particular university, staffing agency, recruiter, receptionist, and the like should be allowed to submit candidates for an employment position. For example, in one embodiment, a company representative may want to specify universities from which to interview candidates for employment positions. The company representative may use a user interface at an evaluator client 806 to select the schools. In one embodiment, the company representative may be able to search for universities by name, state, or other appropriate indexing. The company representative can select a school which authorizes the school to present candidates. Once an evaluator selects a school, the school can be automatically notified that the school has been granted access to the particular company account. The school can then add candidates to interviews that have been posted by the company to the school. Posted interviews can be advertised to the student body using traditional methods. Students can contact the career center at the school and request to interview for the company. The career center can access a user interface that shows companies and company postings. A student can then be added to a candidate pool in which they are interested. In one embodiment, student information can be added to the company's account. When the on-line interview is conducted, it is saved to the company's account and the career center does not have access to the interview.

At 810 application materials are received by the server which are sent from an interviewee client 802. Application materials 810 may be for example, an electronic version of a resume, information from an on-line job application, information entered by a campus career center, or other similar information.

A company representative at an evaluator client 806 can review potential candidates by their application materials 810 and select candidates to be interviewed by sending a select candidate message 812 from an evaluator client 806 which is received at the server 804. The server 804 can notify interviewees by sending an invitation and access credentials 814 to interviewee clients 802. As noted previously herein, different actual machines may be used to implement the functionality of the interviewee clients 802. For example, an interviewee's own personal home computer may receive an email message which includes the invitation and access credentials 814. The actual on-line interview may take place on a different computer, but the interviewee's own personal home computer still implements interviewee client 802 functionality.

The access credentials may be some type of token, identifier, and the like, such as a user name and password, that may be provided to the server 804 to access the server 804 to have an interview taken. For example, as illustrated, the access credentials 816 are sent by an interviewee client 802 and received by the it server 804. The server 804 can then authenticate a candidate so that the candidate can take the interview. In one embodiment, the access credentials may include the interview code described previously that allows the candidate to take the appropriate interview.

To take the interview, questions 820 are sent by the server 804 and received by an interviewee client 802. As mentioned previously, the interviewee client 802 may be for example, an interviewee's own personal computer, an on-site computer, an off-site computer, etc. As mentioned previously, an indicator of when the question 820 was sent may be maintained by the server 804 so as to limit the amount of time that an interviewee has to read and comprehend the question 820 or to time the amount of time an interviewee takes to respond to the question 820. As described previously, the questions may be for example, audio/video recorded questions; multiple choice questions; true/false questions; yes/no questions; short answer questions, where the interviewee is asked to type in a response; uploaded file document based questions, such as a diagram, a section of text, mathematical problems and the like with one or more questions asking the interviewee to view and analyze the file document; etc.

Responses 822 are sent by an interviewee client 802 and received by the server 804 in response to the question 820. An audio/video recorded question may be sent as a text question that is answered by responding verbally while being recorded by a camera and microphone. In one embodiment, the response 822 to an audio/video question may be streamed to the server 804. For example, using streaming audio and video technology, the audio and video of the response 822 is sent directly to the server 804 in near real time. While a temporary cache of some of the audio and video data may be maintained at the interviewee client 802, a permanent cache is not maintained. In one embodiment, this provides increased security in that confidential responses 822 can only be made available by the server 804 and are thus not accessible by having been stored at the interviewee client 802 where they were provided.

Multiple choice responses 822, true/false responses 822; yes/no responses 822; and short answer responses 822 may be provided by an interviewee at an interviewee client 802 by the interviewee selecting appropriate check boxes, radio buttons, or filling in text boxes. Uploaded file document based responses, may be provided by scanning documents, uploading electronic documents, sketching on a pen tablet input device, inputting drawings and text by using interface devices such a mouse and keyboard, etc.

Interviews that have been taken can then be viewed by an evaluator at an evaluator client 806. However, the ability of an evaluator to view an interview may be limited by role and may be specified by a company representative with a more senior role. For example, an administrative user such as a master company member may have the ability to specify other company member's rights in the interview process. For example, a master company member may be able to specify what members have rights to create interview, add questions to interview, add candidates to interviews, add college access to interview, watch and evaluate interviews, create accounts with an interview hosting company, create groups of candidates for a particular viewing audience, grant and revoke rights to access groups, etc.

For example, a company may have a database with over 1000 interviews from candidates, which may include video data files, and/or typed/selected responses, for 50 different positions. A master company member may wish to show three particular candidates to a hiring manager but does not want to allow the hiring manager to see the entire pool of candidates. As such, the master company member can create an account for their hiring manager including a “User” status. From there, the master company member can define one or more a groups within a group of interviews. This may be done, for example, by dividing by job title. The master company member can then name the group and select which candidates out of the larger group candidates they want the hiring manager to see. When the hiring manager logs into interview server 804, the hiring manager will be brought to a view page where the hiring manager will only see the groups of interviews to which the master company member has granted him access. For example, the server 804 may only provide a user interface to the evaluator client 806 that includes the groups specified by the master company member. The hiring manager can select the group to view and will then proceed into an evaluator screen provided by the server 804 to the evaluator client 806 such as the user interface 700 illustrated in FIG. 7 where the hiring manager can watch and evaluate the interviews to which the hiring manager has been granted access.

Returning once again to FIG. 8, an evaluator as described above, can select an interview to view by sending a select interview message 824 from the evaluator client 806 which is received at the server 804. The evaluator may then be presented with a user interface, such as user interface 700 shown in FIG. 7 to evaluate the different candidates giving interviews.

The evaluator at the evaluator client can send a select candidate message 826 from the evaluator client 806 that is received at the server 804. For example, as illustrated in FIG. 7, the evaluator can select a candidate by selecting a link on the list of candidates in the user interface 700 that is displayed on an evaluator client 806. When the evaluator selects a candidate from the user interface 700, the select candidate message is sent from the evaluator client 806 to the server 804. An evaluator may select candidates by selecting up and down arrows on the navigation button 726.

As illustrated in FIG. 8, an evaluator client may also 806 may also send a select question message 828 that is received by the server 804. For example, an evaluator may use the user interface 700 displayed at the evaluator client 806 to select a question by selecting a question link such as the one shown at 704 or by selecting one of the right or left arrows of the navigation button 726. This causes a select question message 828 to be sent to the server 804. Notably, the messaging shown in FIG. 8 is not necessarily in the order depicted therein. For one specific example, it should be noted that select candidate messages 826 and select question messages 828 can be sent in a different order than what is depicted. As described previously, a response may be selected and then each candidate's response to the question can be evaluated in a somewhat “side-by-side” direct comparison manner. Alternatively, a candidate may be selected, and some or all of the responses for that candidate may be reviewed before proceeding on to another candidate.

FIG. 8 illustrates that the response 822 is sent from the server 804 to the evaluator client 806. For example, the server 804 may send an interviewee's textual responses, files, images, audio/video or other responses 822 to the evaluator client 822. Notably, the server 804 may include streaming capabilities, such as those provided by Macromedia Flash Server such that audio/video responses can be streamed to the evaluator client 806.

While not shown in FIG. 8, other messages including some outlined previously herein may be sent between the server 804 and the interviewee clients 802 and evaluator clients 806. As an example, messages may be sent from the evaluator client 806 to the server 804 with comments to be added in the add comments field 722 of the user interface 700. Other overhead, authentication, etc. messages may also be sent.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As just one illustrative example, the server 804 may include computer executable instructions stored on a computer hard disk to enable the sending of messages and storing of data.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for on-line interview processing, comprising:
(A) designing an online interview;
(B) conducting an online interview;
(C) viewing the results of an online interview; and
(D) evaluating an online interview.

2. A method for on-line interview processing, as recited in claim 1, further comprising receiving job seeker information.

3. A method for on-line interview processing, as recited in claim 2, further comprising reviewing said received job seeker information.

4. A method for on-line interview processing, as recited in claim 1, wherein said designing an online interview further comprises:
(1) entering job title and description;
(2) creating questions;
(3) receiving candidate information;
(4) preparing an evaluation; and
(5) displaying a summary and payment page.

5. A method for on-line interview processing, as recited in claim 4, wherein said creating questions, further comprises:
(a) receiving a question type;
(b) receiving a question; and
(c) receiving a correct answer if said received question has a correct answer.

6. A method for on-line interview processing, as recited in claim 4, wherein said receiving candidate information, further comprises:
(a) receiving candidate contact information;
(b) adding candidate name to contact list; and
(c) setting up an interview.

7. A method for on-line interview processing, as recited in claim 4, wherein said preparing an evaluation, further comprises:
(a) receiving an identification of evaluators; and
(b) receiving an evaluation criteria.

8. A method for on-line interview processing, as recited in claim 1, wherein said conducting an online interview further comprises presenting an interviewee with one or more questions, storing one or more responses to said questions, timing said interviewee in responding to said one or more questions and storing an audio and video file of said interviewee responding to said one or more questions.

9. A method for on-line interview processing, as recited in claim 1, wherein said viewing the results of said on-line interview, further comprises:
(1) selecting an interview;
(2) watching said interview; and
(3) evaluating said interview.

10. A method for on-line interview processing, as recited in claim 9, wherein said selecting an interview, further comprises:
(a) displaying a menu of interviews; and
(b) receiving a selection of an interview from said menu of interviews.

11. A method for on-line interview processing, as recited in claim 9, wherein said watching an interview, further comprises:
(a) posting a thumbnail picture taken during said conducted interview;
(b) receiving a selection of a question;
(c) receiving ratings;
(d) checking for other comments; and
(e) displaying biographical information.

12. A method for on-line interview processing, as recited in claim 9, wherein said evaluation, further comprises:
(a) displaying a compilation page; and
(b) displaying a results page.

13. A method for on-line interview processing, as recited in claim 2, wherein said receiving job seeker information, further comprises:
(A) receiving a job seeker profile;
(B) receiving job seeker pre-interview information;
(C) receiving job seeker interview answers; and
(D) storing said profile, information and answers in a database.

14. A method for on-line interview processing, as recited in claim 3, wherein said reviewing said job seeker information, further comprises:
(A) receiving a selection criteria;
(B) displaying query results;
(C) receiving the selection of one or more names;
(D) displaying pre-interview information and resumes for said selected one or more names;
(E) receiving a contact list; and
(F) offering a custom on-line interview.

15. A system for on-line interview processing, comprising:
(A) a Web Server computer executing a method for interview processing;
(B) a database storage device connected to said Web Server computer;
(C) one or more interview designer computers connected over a network to said Web Server computer;
(D) a communications server computer connected to said Web Server computer; and
(E) one or more interview taker computers connected over a network to said communications server computer.

16. A system for on-line interview processing, as recited in claim 15, further comprising one or more evaluator computers connected over a network to said Web Server computer.

17. In a computing system, a method of accomplishing on-line interviewing which allows a candidate to provide responses to interview questions and allows an evaluator to subsequently review the candidates responses, the method comprising;
providing an invitation to an interviewee to take an interview;
receiving access credentials from an interviewee client computer for the interviewee;
providing one or more interview questions to the interviewee client computer system;
receiving responses to the one or more questions from the interviewee client computer system; and
providing the responses to an evaluator client computer system.

18. The method of claim 17, wherein receiving responses to the one or more questions comprises receiving streaming audio and video.

19. The method of claim 17, wherein providing the responses to an evaluator client computer system comprises streaming audio and video.

20. The method of claim 17, further comprising providing a user interface to the evaluator client that includes groups defined by an administrative user so as to limit the interviews available to a user at the evaluator computer system.
